(19) United States
(12) Patent Application Publication
(10) Pub. No.: US 2014/0025510 A1
(43) Pub. Date: Jan. 23, 2014

(54) INVENTORY VIDEO PRODUCTION

(71) Applicant: Sudheer Kumar Pamuru, West Des Moines, IA (US)

(72) Inventor: Sudheer Kumar Pamuru, West Des Moines, IA (US)

(21) Appl. No.: 13/555,586

(22) Filed: Jul. 23, 2012

(51) Int. Cl. G06Q 30/02; G06F 15/16

(52) U.S. Cl. 705/14.72

(57) ABSTRACT

A computer implemented method of generating video promotional material and annotating the video promotional material with information about the product being promoted in the video promotional material, determining where the information about the product is stored, associating the information with the video and adding the information to the video promotional material in the form of video effects.

### TECHNICAL FIELD

The following disclosure relates generally to inventory video production and, more particularly, to the automatic annotation and syndication of product advertisement videos.

### BACKGROUND

Video advertising is known in the art. For retailers with large numbers of unique items for sale, such as used automobiles or real estate, it is desirable to produce videos of each product to allow potential buyers to view the inventory without traveling to the locations of the products, and to rapidly search and compare the products with other products. While such videos may increase the likelihood of the product being sold, and match a potential customer more quickly with a desired product, such videos often lack information desired by potential customers. It is possible to manually edit the videos to add video effects, which include additional information, and audio tracks to increase the appeal of the videos to potential customers. Manually searching and retrieving product information from a database and adding the information to the video, in the form of a video or audio effect, however, can consume an undesirable amount of time and resources that could otherwise be used to produce additional videos. Providing videos with a consistent naming convention and syndicating the videos on various platforms for access by potential customers can also be costly and time consuming. Thus, there is a need for a product video production system that reduces the amount of time and costs associated with adding video effects, audio effects, product specific information, and consistent file names to videos, and syndicating the videos on the appropriate platforms for review by potential customers.

### SUMMARY OF THE DISCLOSED SUBJECT MATTER

### Overview

A system for generating a video includes a database of information relating to a retailer's inventory of products. A video of a product in the inventory is created and matched with a record of information selected from the database that relates to the product. The video is transmitted across a network. Video effects, including the record of information, are added to the video, along with audio effects. The video is named according to a predetermined naming convention and the video is syndicated across a network for viewing by potential customers.

### BRIEF DESCRIPTION OF THE DRAWINGS

The present invention will now be described, by way of example, with reference to the accompanying drawings in which:

FIG. 1 is a component diagram of components included in a typical implementation of the system in the contest of a typical operating environment;

FIG. 2 is a flow diagram showing steps typically performed by the system to produce and syndicate a video of a product;

FIG. 3 is a display diagram showing a display of a product category menu;

FIG. 4 is a display diagram showing a display of a product menu;

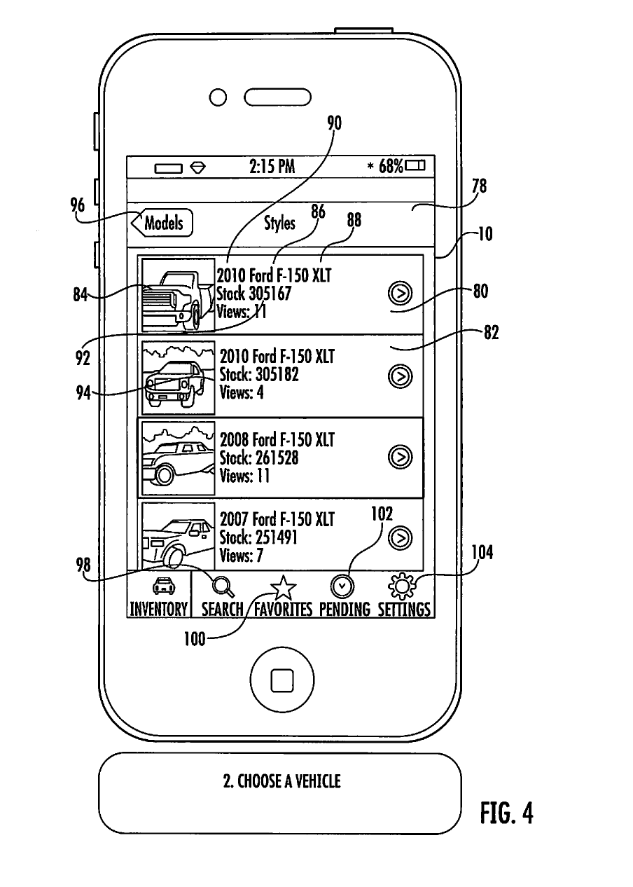

FIG. 5 is a display diagram showing a display of a record menu;

FIG. 6 is a display diagram showing a display of a digital file naming screen;

FIG. 7 is a display diagram showing a display of a recording interface;

FIG. 8 is a display diagram showing a display of a recording screen;

FIG. 9 is a display diagram showing a display of a video upload screen; and

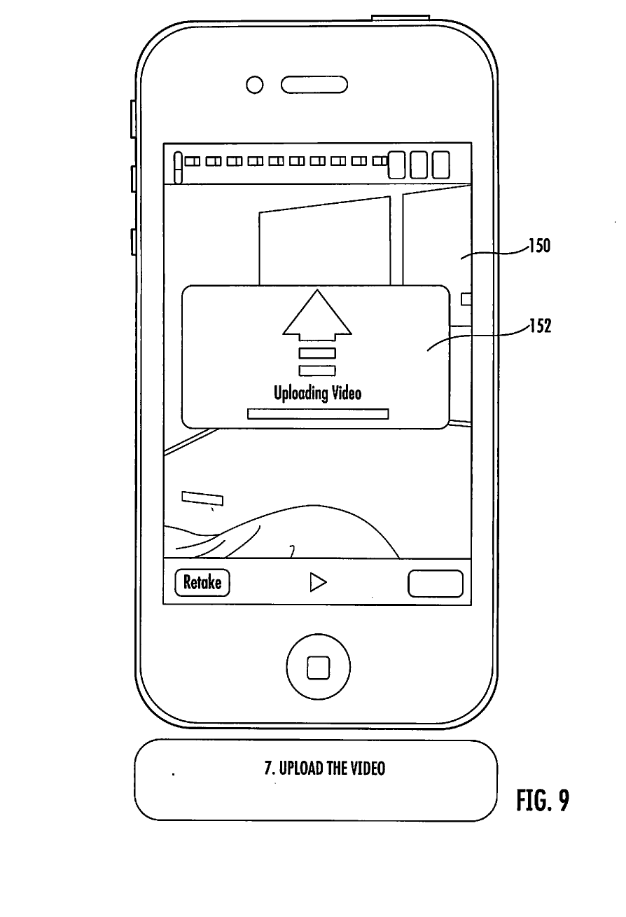

FIG. 10 is a display diagram showing a display of a video detail screen.

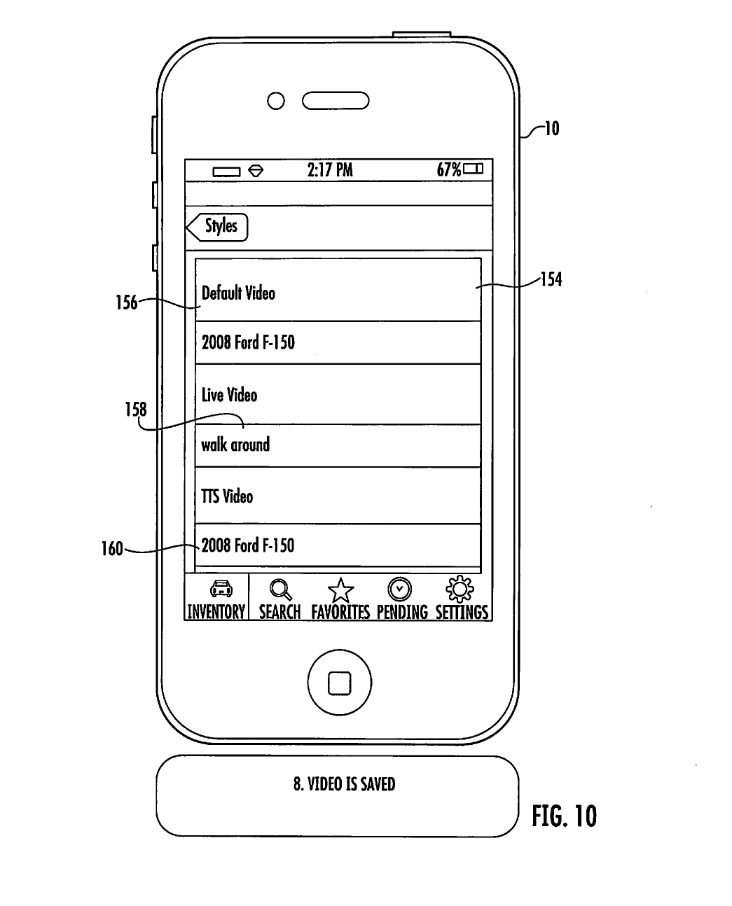

### DETAILED DESCRIPTION OF THE DRAWINGS

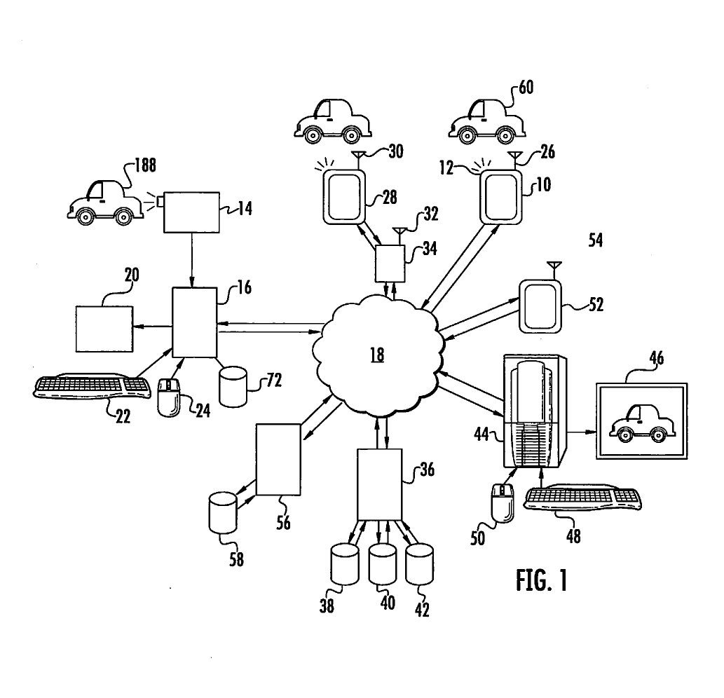

FIG. 1 is a component diagram of components included in a typical implementation of the system in the context of a typical operating environment. As illustrated, the operating environment includes one or more mobile devices (10) provided with a video capture system (12) such as a video camera. The mobile device (10) may be a computer having a memory containing computer executed instructions for processing information. The video capture system (12) may be of any type known in the art, but is preferably combined with the mobile device (10) in a mobile computing platform provided with an integrated video camera, such as an iPhone® manufactured by Apple, Inc. Preferably, the mobile device (10) is integrated with the video capture system (12).

Alternatively, a stand-alone video camera (14) may be coupled to a computer (16) having a memory containing computer executable instructions for processing information and coupled to a network (18), such as a global computing network. The computer (16) is preferably provided with a display (20) and input devices, such as a keyboard (22) and a mouse (24). The video camera (14) may be coupled to the computer (16) either using a direct wire or wireless connection.

When using the mobile device (10), the mobile device is provided with an antenna (26) to wirelessly connect to the network (18). Alternatively, a mobile device (28) may be provided with an antenna (30) to wirelessly connect to an antenna (32) provided on a base station (34) which, in turn, is coupled to the network (18). Also connected to the network (18) is a server (36) which, in turn, is coupled to one or more databases (38), (40) and (42).

Coupled to the network (18) is a user computer (44) having a memory containing computer executable instructions for processing information. The user computer (44) is coupled to a display (46) and input devices, such as a keyboard (48) and mouse (50). Other devices, such as a tablet computer (52) having an antenna (54), and a search engine server (56) coupled to a database (58), may also be coupled to the network (18). The foregoing devices may be coupled to the network (18) and to one another by any means known in the art, and may be operable in accordance with many commercial transaction communication protocols.

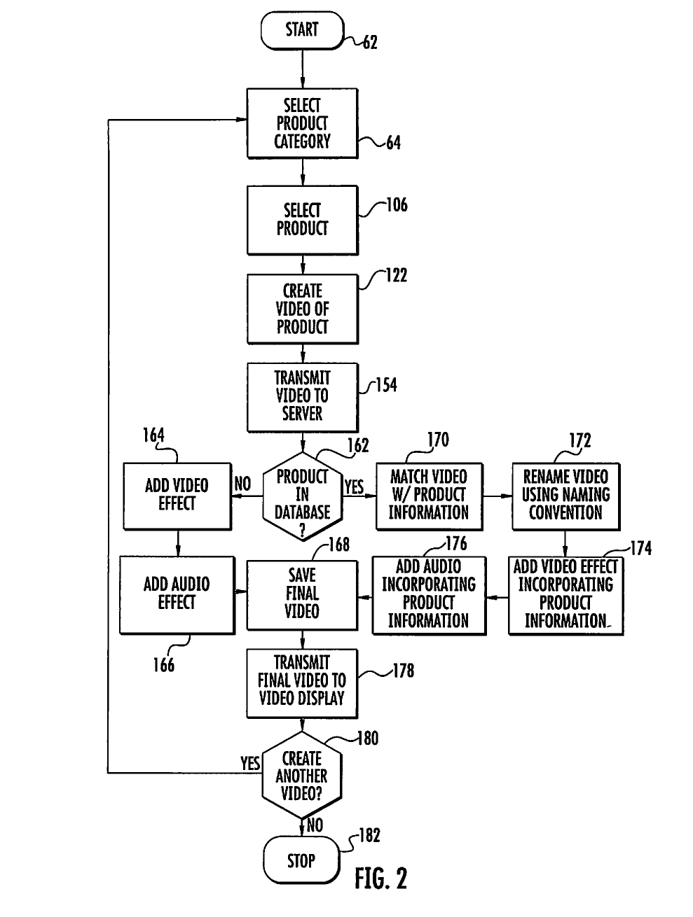

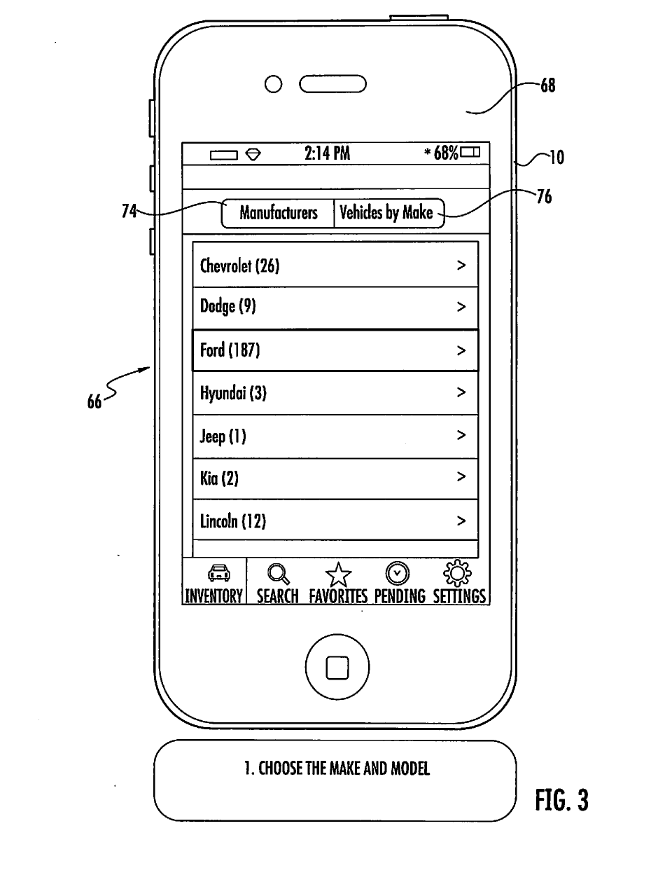

FIG. 2 is a flow diagram showing the steps typically performed by the system for producing a video associated with a product (60), such as a vehicle. The first step is for a user to use the mobile device (10) to select (64) a product category. As shown in FIG. 3, the mobile device (10) executes instructions to display a product category menu (66) on the screen (68) of the mobile device (10). The product category menu (66) displays a plurality of product categories (70) associated with various products stored in the database (38) associated with the server (36). Alternatively, the product information may be stored in a database (72) associated with the retailer's computer (16). Preferably, the retailer has input into the database (38) an inventory of products (60), comprising for each product (60) a set of information that may include a primary characteristic associated with the first product such as price, a supplemental characteristic associated with the first product, such as mileage, and any other desired characteristics. Alternatively, a product, such as real estate, artwork, or the like may be placed into the inventory along with their associated characteristics.

As shown in the product category menu (66), the product category menu (66) may be sorted by various criteria by selecting buttons (74) and (76) above the product category (70). Once the user selects (64) the desired product category (70) of a product desired to be the subject of the video, the mobile device (10) executes instructions to display the product menu (78) comprising details (80) and (82) relating to various vehicle having information stored in the database (38). The details (80) and (82) may include a photograph (84), the make (86), model (88) and year (90) of the vehicle. The details (80) and (82) may contain additional information such as a vehicle ID number (92) the number of views (94) associated with the vehicle. The product menu (78) also includes additional buttons, such as a “back” button (96), a “search” button (98) or “favorites” button (100) to identify entries previously tagged as “favorites” by a user. The product menu (78) may also include a “pending” button (102) to display items for which a sale is currently pending and a “settings” button (104) to adjust various user defined settings in a manner such as that known in the art.

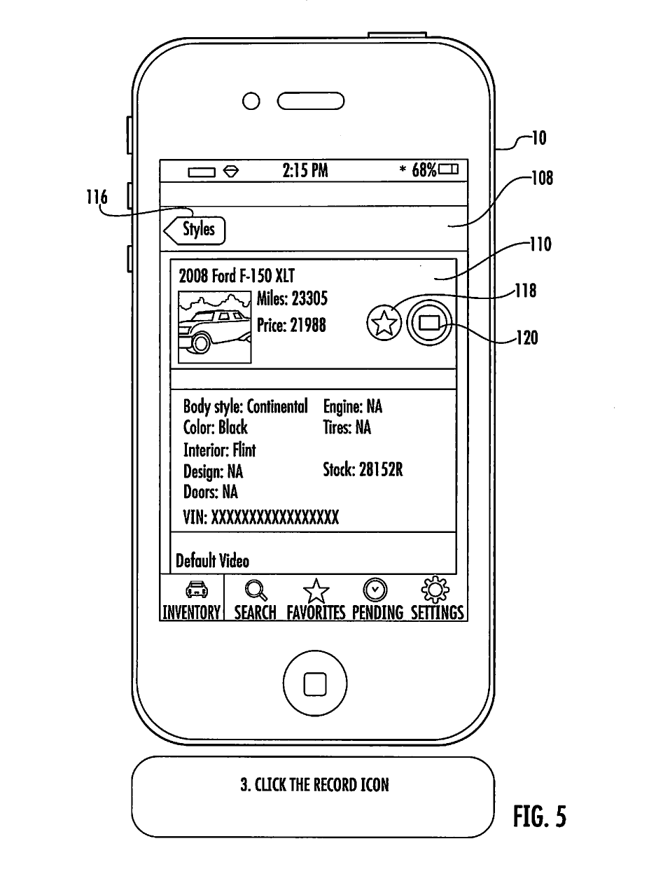

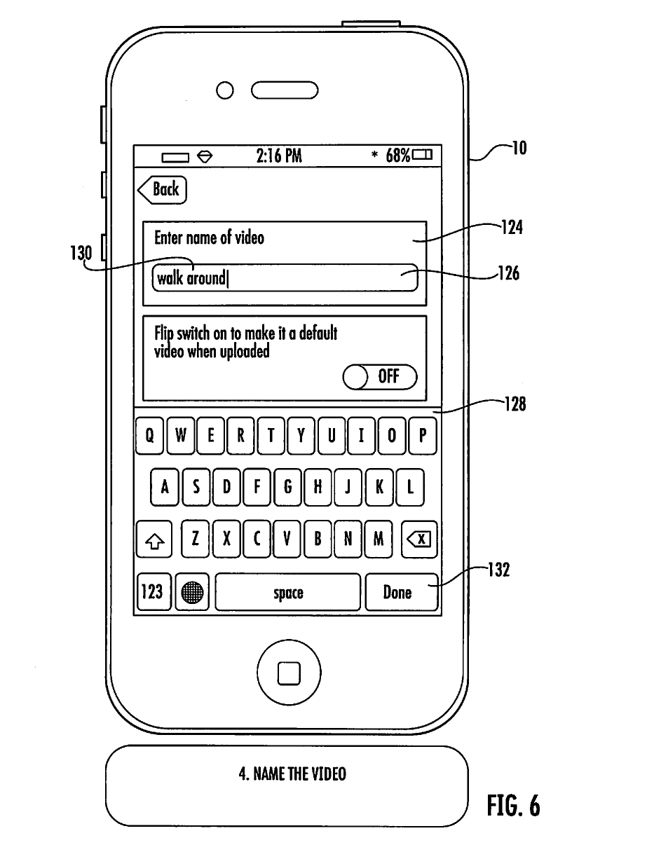

From the product menu (78), a user selects (106) the desired product for which the user wishes to create a video. Selecting (106) a product from the product menu (78) causes the mobile device (10) to execute instructions to display the record menu (108), shown in FIG. 5. (FIGS. 2 and 5). The record menu (108) comprises a detail field (110) that includes information (112) relating to the product, along with a photograph (114) of the product (60). The record menu (108) also includes a back button (116), a favorite button (118) to tag the product as a “favorite,” and a record button (120). When it is desired to create (122) a video of the product (60), the user selects the record button (120) which causes the mobile device (10) to execute instructions to display the video file naming screen (124). (FIGS. 2, 5 and 6).

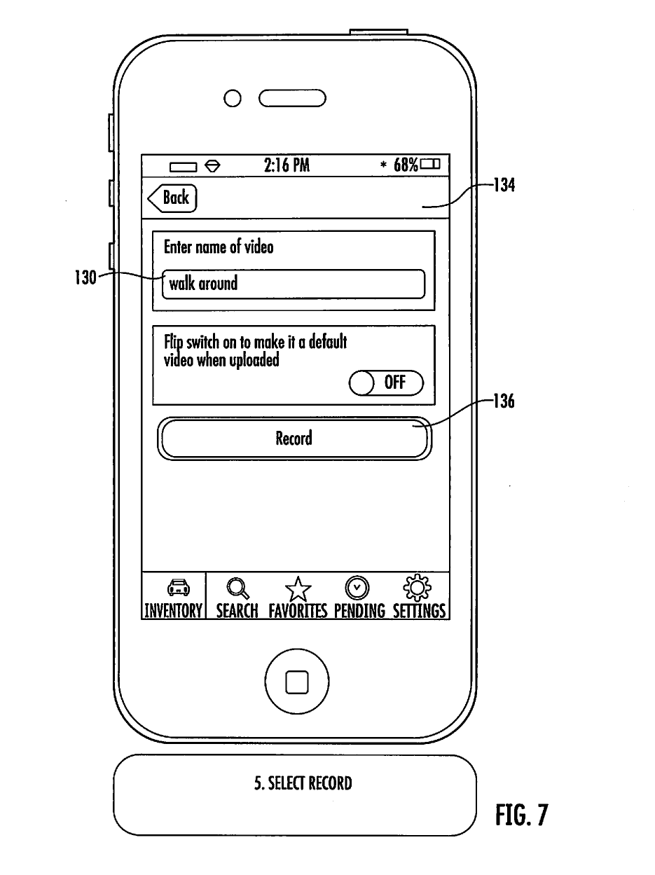

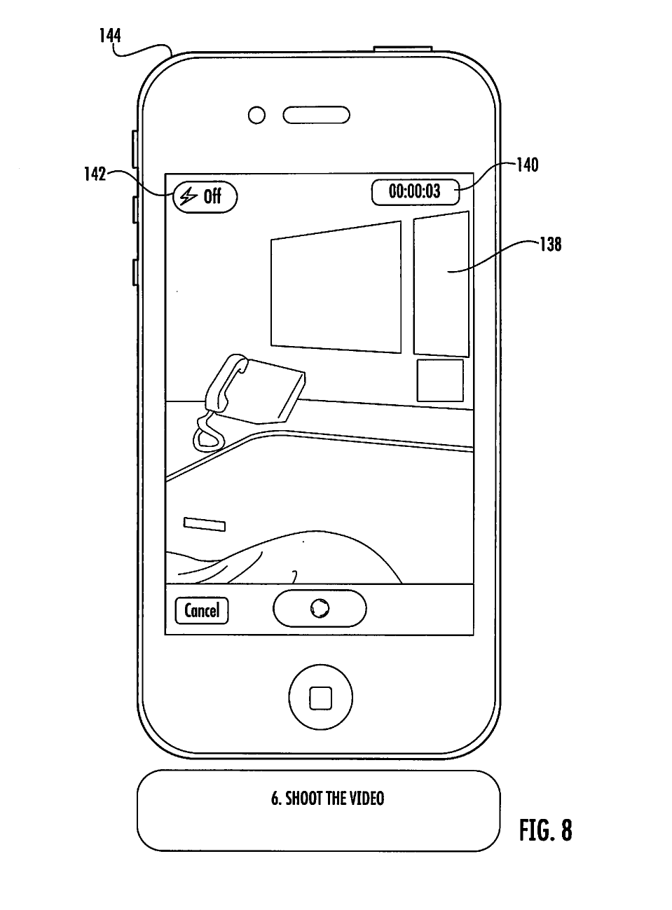

The video file naming screen (124) includes an input field (126) and a keyboard (128) to allow a user to input a file name (130) to be associated with the video. Once the user has entered the name of the video and selected the done button (132), the mobile device (10) executes instructions to display the recording interface (134) shown in FIG. 7. The recording interface (134) includes the file name (130) and a start record button (136). Selecting the start record button (136) causes the mobile device (10) to execute instructions to cause the video capture system (12) associated with the mobile device (10) to display the recording screen (138) and begin recording a video of the product (60). (FIGS. 2, 7 and 8). The recording screen (138) includes a timer (140), a light button (142) to toggle on and off a light (144) associated with the mobile device (10), a cancel button (146) to cancel the video recording, and a stop recording button (148) to stop the recording when the video is complete.

Once the user selects the stop recording button (148), the mobile device (10) executes instructions to display the video uploading screen (150) that includes a status bar (152) indicating automatic transmission (154) of the recorded video from the mobile device (10) across the network (18) to the server (36). Once the transmission (154) of the video to the server (36) is complete, the mobile device (10) executes instructions to display the video detail screen (156) that lists the various categories of videos, such as a designated default video (158), the most recent video (160), as well as additional categories (162). Once the server (36) has received the video, the server (36) checks (164) to determine whether information related to the product in the video is stored in the database (38).

As shown in FIG. 2, if the product is locked in the database (38), the server (36) adds (166) predetermined video effects to the video, such as overlay and swipes. Additionally, the server (36) may edit the length of the video. The server (36) may also add (168) audio effects to the video, such as predetermined music or voiceovers. Preferably, the server (36) is programmed to execute instructions to annotate the video automatically to add (166) video effects and add (168) audio effects. Alternatively, the video may be saved (170) without adding any effects.

If the server checks (164) and finds information related to the product in the database (38), the server (36) matches (172) the video with the product information stored in the database. The server (36) then renames (174) the video, or otherwise tags the video to indicate that the video is associated with the product information stored in the database (38). After renaming (174) the video, the server (36) adds (176) video effects to the video. Preferably, the server (36) adds (176) video effects to the video that incorporates at least a portion of the product information stored in the server (38). Such video effects may include overlays of information related to the price, mileage, condition, color, make, model or other stored characteristic of the product (60).

The server (36) also adds (178) audio effects to the video that incorporate product information. Such audio effects may include automated voiceovers relating to price, condition, color, mileage, or other characteristic of the product (60). Once the server (36) has completed the addition of video and audio effects to the video, the server (36) saves (180) the final video on the server (36). While the video may be edited manually, in the preferred embodiment, the server (36) automatically adds (176) and (178) video and audio effects in automatic response to transmission (154) of the video to the server. Once the server (36) has saved (180) the final video, the server (36) may upload the video to the retailer's computer (16), which the retailer may store in the database (72) coupled to the computer (16). The server (36) may also transmit (182) the final video to a user's computer (44) associated with a prospective customer for viewing on the display (46). Alternatively, the server (36) may upload the video to a subscription website, such as youtube.com, syndicate the video, or upload the video to a third party server for access therefrom by potential customers. Thereafter, a user may decide (184) whether to create another video. If the user wishes to create another video, the process returns to (64) and repeats. If the user does not wish to create another video, this routine finishes (186).

As shown in FIG. 1, any desired device, such as a tablet (52) may be used to create and send video to the server (36) across the network (18), or to display videos received from the server (36). Additionally, a search engine (56) may be used to search and access videos stored on the server (36) or elsewhere.

Although a few implementations have been described in detail above, other modifications are possible. Moreover, other mechanisms for generating video, matching the video with product information, and incorporating the product information into the video in the form of video effects may be used. In addition, the logic flow depicted in FIG. 2 does not require the particulars order shown or sequential order to achieve the desirable result. Other steps may be provided, or steps may be eliminated from the described flow, and other components may be added to, or removed from, the described systems. Accordingly, other implementations are within the scope of the following claims.

What is claimed is:

1. A computer implemented method for generating a video, comprising:
(a) providing a retailer having an inventory comprising an item;
(b) providing a database comprising a record of information relating to the item;
(c) accessing the database;
(d) selecting the record from the database;
(e) creating a video of the item;
(f) generating a tagged video associating the video with the record of information selected from the database;
(g) transmitting the tagged video across a global computer network to a server;
(h) in response to the step of transmitting the tagged video, processing the tagged video to create a final video; and
(i) transmitting the final video across the global computer network for display to a viewer of a video display system.

2. The computer implemented method for generating a video of claim 1, wherein processing the tagged video comprises adding an overlay to the video.

3. The computer implemented method for generating a video of claim 1, wherein processing the tagged video comprises:
(a) associating the video with a location;
(b) associating an overlay with the location; and
(c) in response to the step of associating the video with a location, adding the overlay to the video.

4. The computer implemented method for generating a video of claim 1, wherein the step of accessing the database comprises accessing the database across a network.

5. A computer implemented method for generating a video, comprising:
(a) providing a first retailer having an inventory comprising a first item;
(b) providing a first database comprising a first set of information regarding the first item, the first set of information comprising:
(i) a primary characteristic associated with the first item; and
(ii) a supplemental characteristic associated with the first item;
(c) accessing the first database;
(d) selecting the first set of information from the first database;
(e) generating a first tagged video associating the first video with the first set of information;
(f) transmitting the first tagged video across a global computer network to a server;
(g) creating a first modified video by a method comprising:
(i) adding to the first tagged video information associated with the primary characteristic of the first item;
(i) adding to the first tagged video information associated with the supplemental characteristic of the first item;
(ii) adding a predetermined video effect to the first tagged video;
(iii) adding a predetermined piece of audio to the first tagged video;
(h) transmitting the first modified video from the server, across a global computer network for display to a first viewer of a first video display system;
(i) providing a second retailer having an inventory comprising a second item;
(j) providing a second database comprising a second set of information regarding the second item, the second set of information comprising:
(i) a primary characteristic associated with the second item; and
(ii) a supplemental characteristic associated with the second item;
(k) accessing the second database;
(l) selecting the second set of information from the second database;
(m) generating a second tagged video associating the second video with the second set of information;
(n) transmitting the second tagged video across the global computer network to the server;
(o) creating a second modified video by a method comprising:
(i) adding to the second tagged video information associated with the primary characteristic of the second item;
(iii) adding to the second tagged video information associated with the supplemental characteristic of the second item;
(iv) adding a predetermined video effect to the second tagged video;
(v) adding a predetermined piece of audio to the second tagged video; and
(m) transmitting the second modified video from the server, across a global computer network for display to a second viewer of a second video display system.

6. The computer implemented method for generating a video of claim 5, wherein adding to the first tagged video information associated with the primary characteristic of the first item comprises adding an overlay to the video.

7. The computer implemented method for generating a video of claim 5, further comprising:
(d) associating the first tagged video with a location;
(e) associating an overlay with the location; and
(f) in response to the step of associating the first tagged video with a location, adding the overlay to the first tagged video.

8. The computer implemented method for generating a video of claim 5, wherein the step of accessing the first database comprises accessing the first database across a network.

9. A computer implemented method for generating a video comprising:
(a) providing a retailer having an inventory comprising an item;
(b) providing a database comprising a record of information associated with the item;
(c) creating a video of the item;
(d) transmitting the video to a server;
(e) in response to the step of transmitting the video to a server, matching the video to the record of information;
(f) renaming the video using a naming convention associating the video with the record of information;
(g) adding a predetermined video effect to the video to create a final video, the predetermined video effect incorporating information from the record of information; and
(h) transmitting the final video across a network for display to a viewer of a video display system.

10. The computer implemented method for generating a video of claim 9, further comprising adding audio to the video.

11. The computer implemented method for generating a video of claim 9, wherein the audio comprises information from the record of information.

12. The computer implemented method for generating a video of claim 8, further comprising syndicating the final video over a global communication network.

13. The computer implemented method for generating a video of claim 8, further comprising transmitting the final video to a supplemental server associated with the retailer.
